(19) United States
(12) Patent Application Publication
(10) Pub. No.: US 2005/0024423 A1
(43) Pub. Date: Feb. 3, 2005

(54) Inkjet recording apparatus and ink cartridge

(75) Inventor: Naoki Katayama, Kariya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/898,284

(22) Filed: Jul. 26, 2004

(30) Foreign Application Priority Data
Jul. 29, 2003 (JP) 2003-203251

(51) Int. Cl. B41J 2/165

(52) U.S. Cl. 347/30

(57) ABSTRACT

An inkjet recording apparatus includes a recording head having nozzle holes, a reserving portion that reserves ink to be supplied to the recording head, a positive-pressure supply unit that supplies positive gas pressure from the outside into the reserving portion to apply positive pressure on ink in the nozzle holes through ink reserved in the reserving portion, a first flow path through which positive-pressure gas flows from the outside into the reserving portion by the positive-pressure supply unit when the difference between the pressure of positive-pressure gas provided by the positive-pressure supply unit and the inner pressure of the reserving portion is not lower than a first predetermined value, and a second flow path through which gas flows out from the reserving portion to the outside when the difference between the inner pressure of the reserving portion and the pressure of the outside is not lower than a second predetermined value.

### BACKGROUND OF THE INVENTION

1. Field of the Invention

The present invention relates to an inkjet recording apparatus and an ink cartridge.

2. Description of the Related Art

An ink cartridge in which ink is reserved has a supply port for supplying ink to a recording head, and an atmospheric air communication hole. At the same time that ink is spent, an amount of the atmospheric air equal to the amount of spent ink is taken in. The atmospheric air communication hole needs to be formed to have a possibly small diameter and a possibly long labyrinthine shape to increase flow path resistance to prevent the water content of ink from being vaporized.

There is an ink cartridge of the type in which positive gas pressure is applied on ink in the ink cartridge when a purging process is carried out to eliminate choking, etc., of nozzle holes of the recording head. A configuration in which the atmospheric air communication hole is formed to have large flow path resistance and in which a pump is disposed on the outside of the atmospheric air communication hole, has been described in JP-A-58-36457.

As disclosed in JP-A-60-204358, it is known that a lead valve which is ordinarily closed by an urging unit such as a spring to reduce vaporization of ink is provided in the atmospheric air communication hole.

### SUMMARY OF THE INVENTION

In the configuration in which the atmospheric air communication hole is formed to have large flow path resistance as disclosed in JP-A-58-36457, increase in pressure in the ink cartridge is delayed by the resistance when positive gas pressure is applied on ink in the ink cartridge through the atmospheric air communication hole by the pump. Moreover, even in the case where the operation of the pump is stopped, pressure in the ink cartridge is hardly reduced. For this reason, there occurs the situation that ink is leaked from the nozzle holes of the recording head for a while due to the remaining pressure.

In the configuration in which the atmospheric air communication hole is blocked with the lead valve as disclosed in JP-A-60-204358, when positive gas pressure is applied on ink in the ink cartridge in the aforementioned manner, the inner pressure of the ink cartridge cannot be restored to pressure in a printing state after the purging process. For this reason, the purging process using positive gas pressure cannot be applied to this configuration.

The present invention is to solve the aforementioned problem and an object of the invention is to provide an inkjet recording apparatus and an ink cartridge in which the water content of ink in the ink cartridge can be prevented from being vaporized and in which pressure can be regulated rapidly when positive pressure is applied on the inside of the ink cartridge.

According to one aspect of the invention, there is provided an inkjet recording apparatus including: a recording head having nozzle holes for ejecting ink; a reserving portion that reserves ink to be supplied to the recording head; a positive-pressure supply unit that supplies positive gas pressure from the outside into the reserving portion to apply positive pressure on the ink in the nozzle holes of the recording head through the ink reserved in the reserving portion; a first flow path through which positive-pressure gas flows from the outside into the reserving portion by the positive-pressure supply unit when the difference between the pressure of positive-pressure gas provided by the positive-pressure supply unit and the inner pressure of the reserving portion is not lower than a first predetermined value; and a second flow path through which gas flows out from the reserving portion to the outside when the difference between the inner pressure of the reserving portion and the pressure of the outside is not lower than a second predetermined value.

According to this inkjet recording apparatus, when the difference between the pressure of positive-pressure gas supplied from the outside to the reserving portion for reserving ink by the positive-pressure supply unit and the inner pressure of the reserving portion is not lower than the first predetermined value, positive gas pressure flows from the outside into the reserving portion through the first flow path. When the positive gas pressure is supplied into the reserving portion, positive pressure is applied on ink in the ink ejecting nozzle holes of the recording head through the ink reserved in the reserving portion. On the other hand, when the difference between the inner pressure of the reserving portion and the pressure of the outside is not lower than the second predetermined value, gas flows out from the reserving portion to the outside through the second flow path.

According to another aspect of the invention, there is provided an ink cartridge used in an inkjet recording apparatus including a recording head having nozzle holes for ejecting ink, a reserving portion that reserves ink to be supplied to the recording head, and a positive-pressure supply unit that supplies positive gas pressure from the outside into the reserving portion to apply positive pressure on the ink in the nozzle holes of the recording head through the ink reserved in the reserving portion, the ink cartridge including: the reserving portion; a first flow path through which positive-pressure gas flows from the outside into the reserving portion by the positive-pressure supply unit when the difference between the pressure of positive-pressure gas provided by the positive-pressure supply unit and the inner pressure of the reserving portion is not lower than a first predetermined value; and a second flow path through which gas flows out from the reserving portion to the outside when the difference between the inner pressure of the reserving portion and the pressure of the outside is not lower than a second predetermined value.

According to this ink cartridge, when the difference between the pressure of positive-pressure gas supplied from the outside to the reserving portion for reserving ink by the positive-pressure supply unit provided in the inkjet recording apparatus and the inner pressure of the reserving portion is not lower than the first predetermined value, positive gas pressure flows from the outside in to the reserving portion through the first flow path. When the positive gas pressure is supplied into the reserving portion, positive pressure is applied on ink in the ink ejecting nozzle holes of the recording head through the ink reserved in the reserving portion. On the other hand, when the difference between the inner pressure of the reserving portion and the pressure of the outside is not lower than the second predetermined value, gas flows out from the reserving portion to the outside through the second flow path.

### BRIEF DESCRIPTION OF THE DRAWINGS

The present invention may be more readily described with reference to the accompanying drawings:

FIG. 1 is a diagram showing an inkjet recording apparatus according to an embodiment of the invention;

FIGS. 2A to 2C are enlarged sectional views showing the configuration of an atmospheric air communication hole control portion, FIG. 2A showing an ordinary state of the atmospheric air communication hole control portion, FIG. 2B showing a state in which gas flows into an ink cartridge, and FIG. 2C showing a state in which gas flows out of the ink cartridge;

FIGS. 3A to 3C are enlarged sectional views showing the atmospheric air communication hole control portion in a second embodiment, FIG. 3A being a top sectional view of the atmospheric air communication hole control portion, FIG. 3B being a sectional view taken along line 3B-3B in FIG. 3A, and FIG. 3C being a sectional view taken along line 3C-3C in FIG. 3A;

FIG. 4 is an enlarged sectional view showing an atmospheric air communication hole control portion in a third embodiment;

FIGS. 5A to 5C are enlarged sectional views showing the configuration of an atmospheric air communication hole control portion in a fourth embodiment, FIG. 5A showing an ordinary state of the atmospheric air communication hole control portion, FIG. 5B showing a state in which gas flows into an ink cartridge, and FIG. 5C showing a state in which gas flows out of the ink cartridge;

FIG. 6 is a diagram showing an inkjet recording apparatus according to still another embodiment; and

FIG. 7 is a sectional view showing atmospheric air communication valves disposed on an upper portion of an ink cartridge.

### DETAILED DESCRIPTION OF THE PREFERRED EMBODIMENTS

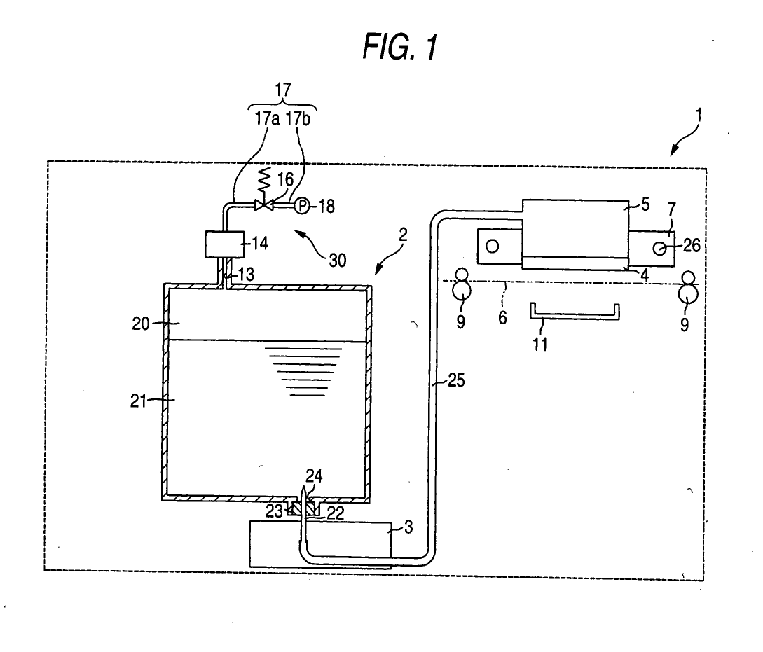

A first preferred embodiment of the invention will be described below with reference to the accompanying drawings. FIG. 1 is a diagram showing an inkjet recording apparatus 1 according to the first embodiment.

The inkjet recording apparatus 1 has a plurality of ink cartridges 2 filled with four kinds of color ink, namely, cyan, magenta, yellow and black, respectively; a mount portion 3 on which the ink cartridges 2 are detachably mounted; a tank 5 for reserving ink provided from each ink cartridge 2 through an ink supply tube 25; a recording head 4 for ejecting ink reserved in the tank 5 toward a printing sheet 6; a carriage 7 which makes reciprocating motion in a linear direction in the condition that the tank 5 and the recording head 4 are mounted in the carriage 7; a carriage shaft 26 which serves as a guide for the reciprocating motion of the carriage 7; a conveyance mechanism 9 for conveying the printing sheet 6; an atmospheric air communication control portion 14; and a positive pressure purging device 30.

Each of the ink cartridges 2 has an ink reserving portion provided in its inside, an extracting port 24 provided in its bottom and sealed with a stopper 23, and an atmospheric air communication path 13 provided in its top. As will be described later, external air is introduced into the ink cartridge 2 through the atmospheric air communication path 13 in accordance with the amount of ink extracted from an extracting needle 22 as ink is ejected from the recording head 4. Each ink cartridge 2 is disposed be low nozzle holes of the recording head 4 so that negative pressure (back pressure) is given to ink in the nozzle holes of the recording head 4.

A hollow extracting needle 22 for extracting ink reserved in each ink cartridge 2 to the outside is disposed so as to protrude from the mount portion 3. When each ink cartridge 2 is mounted on the mount portion 3, the extracting needle 22 pierces the stopper 23 so as to come into contact with ink. Incidentally, the stopper 23 is made of an elastic member such as butyl rubber having an electric functioning which the stopper 23 can be pierced by the extracting needle 22 and in which the stopper 23 can be restored to a sealed state after the extracting needle 22 is removed from the stopper 23. A lower end of the extracting needle 22 is connected to the tank 5 through the ink supply tube 25.

A plurality of nozzle holes are provided in the recording head 4. Ink reserved in the tank 5 is ejected from the nozzle holes. In a printing operation, ink is ejected while the carriage 7 makes reciprocating motion to thereby perform printing on the printing sheet 6. In a purging process, the recording head 4 is moved to a purging execution position set on the outside of a print range, so that ink including air bubbles and foreign substances such as impurities is discharged toward a waste ink tank 11 provided in the purging execution position.

The atmospheric air communication control portion 14 is connected to the atmospheric air communication path 13 of each ink cartridge 2. The positive pressure purging device 30 is connected to the atmospheric air communication control portion 14. The positive pressure purging device 30 has an air pump 18 which is a pump for supplying positive-pressure gas into each ink cartridge 2 through the atmospheric air communication control portion 14 and the atmospheric air communication path 13, a tube system 17 made of tubes 17a and 17b for connecting the air pump 18 and the atmospheric air communication control portion 14 to each other, and a pressure-regulating valve 16 inserted in the tube system 17 for regulating pressure.

Incidentally, a central processing unit (hereinafter referred to as “CPU”) (not shown) is mounted in the inkjet recording apparatus 1. A recording operation and other operations such as a purging operation are controlled under the CPU.

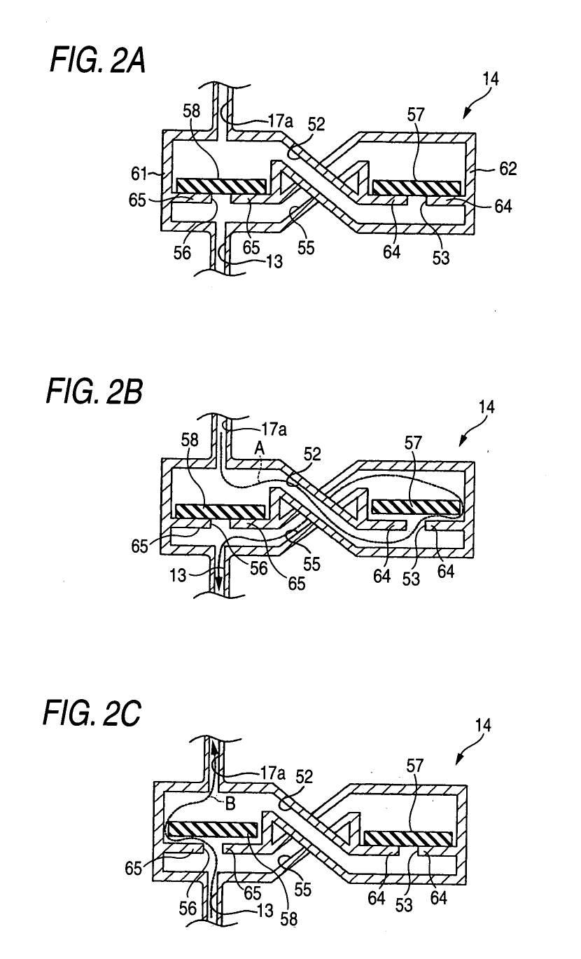

FIGS. 2A to 2C are enlarged sectional views showing the configuration of the atmospheric air communication control portion 14. FIG. 2A shows an ordinary state of the atmospheric air communication control portion 14. FIG. 2B shows a state in which gas flows into each ink cartridge 2. FIG. 2C shows a state in which gas flows out of each ink cartridge 2.

The atmospheric air communication control portion 14 has two hollow housings 61 and 62, and two partition walls 65 and 64 provided in the housings 61 and 62 respectively for partitioning inner spaces of the housings 61 and 62 into upper and lower parts respectively. The upper space of the first housing 61 is connected to the air pump 18 through the tube 17a. The lower space of the first housing 61 is connected to the atmospheric air communication path 13. The upper space of the second housing 62 is connected to the lower space of the first housing 61 through a communication path 55. The lower space of the second housing 62 is connected to the upper space of the first housing 61 through a communication path 52.

Communication holes 56 and 53 for connecting the upper and lower spaces of the housings 61 and 62 to each other respectively are formed in the partition walls 65 and 64 respectively so that the communication holes 56 and 53 pass through the partition walls 65 and 64 respectively. Valves 58 and 57 are supported on upper surfaces of the partition walls 65 and 64 respectively so that the communication holes 56 and 53 are covered with the valves 58 and 57 respectively. In an ordinary state, the valves 58 and 57 abut on the partition walls 65 and 64 to block the communication holes 56 and 53 on the basis of their own weights respectively. When pressure of gas through the communication holes 56 and 53 is applied on the valves 58 and 57 to lift the valves 58 and 57 against their own weight, the valves 58 and 57 are opened. The outer diameter of each of the valves 58 and 57 is smaller than the inner diameter of corresponding one of the housings 61 and 62. A gap is provided between the outer circumference of each of the valves 58 and 57 and the inner surface of corresponding one of the housings 61 and 62 so that gas is allowed to flow through the gap when corresponding one of the communication holes 56 and 53 is opened. Although the valves 58 and 57 are urged to abut on the partition walls 65 and 64 respectively by gravity in this case, the invention may be also applied to the case where another means such as a spring is used in combination with the gravity for urging the valves 58 and 57. The partition walls 65 and 64 serve as support portions (described in Claims) for supporting the valves 58 and 57 respectively.

In an ordinary printing state, the communication holes 56 and 53 are blocked with the valves 58 and 57 respectively, so that the inside of each ink cartridge 2 is in a nearly sealed state to prevent the water content of ink from being vaporized. When ink in each ink cartridge 2 is extracted by the aforementioned ink ejecting from the recording head 4, the inner pressure of the ink cartridge 2 is reduced. When the pressure of the upper space of the second housing 62 connected to the atmospheric air communication path 13 is reduced to be lower by the weight of the valve 57 than the atmospheric air pressure acting on the lower space of the second housing 62, the valve 57 is lifted by the differential pressure so that the atmospheric air is introduced into the ink cartridge 2 through the second housing 62 and the atmospheric air communication path 13.

Incidentally, the air pump 18 in a stop state connects the tubes 17a and 17b to the atmospheric air through the inside of the air pump 18, that is, keeps the inner pressure of the tubes 17a and 17b equal to the atmospheric air pressure. In the aforementioned printing state, the valve 58 in the first housing 61 blocks the communication hole 56 on the basis of the pressure difference between the upper and lower spaces of the first housing 61.

Next, the operation of the atmospheric air communication control portion 14 at the time of execution of the purging process will be described. The purging process is executed as follows. In the condition that the recording head 4 is moved to a purging execution portion, the air pump 18 supplies positive gas pressure into each ink cartridge 2 to increase the inner pressure of the ink cartridge 2 to thereby forcedly discharge ink from the nozzle holes of the recording head 4 toward the waste ink tank 11.

When the air pump 18 is driven to supply positive gas pressure into the atmospheric air communication control portion 14 through the tube system 17, positive pressure is applied on the valve 58 from above so that the valve 58 is closed. On the other hand, when positive pressure is applied on the valve 57 from below and the pressure becomes higher than the weight of the valve 57, the valve 57 is lifted so as to be opened. For this reason, the positive gas pressure provided from the air pump 18 is supplied into the ink cartridge 2 through the tube system 17, the communication path 52, the communication hole 53, the communication path 53 and the atmospheric air communication path 13 (flow path A in FIG. 2B). When the positive gas pressure is continuously supplied into the ink cartridge 2, ink is discharged from the nozzle holes so that foreign substances blocking the nozzle holes are discharged together with the ink to the waste ink tank 11.

When a predetermined time for supply of the positive gas pressure by the air pump 18 has passed, driving of the air pump 18 is stopped so that supply of the positive gas pressure is stopped. At the point of time when supply of the positive gas pressure by the air pump 18 is stopped, gas in the ink cartridge 2 flows out to the outside because the pressure of gas in the ink cartridge 2 is still higher than the atmospheric air pressure. In this case, high gas pressure is applied on the valve 57 from above so that the valve 57 is closed whereas high gas pressure is applied on the valve 58 from below so that the valve 58 is lifted so as to be opened when the gas pressure is higher than the weight of the valve 58. For this reason, the high-pressure gas in the ink cartridge 2 flows out to the outside through the atmospheric air communication path 13, the communication hole 56 and the tube system 17 (flow path B in FIG. 2C).

When the gas pressure in the ink cartridge 2 almost approaches the atmospheric air pressure, the valve 58 moves down on the basis of its own weight to block communication between the inside and the outside of the ink cartridge 2. Incidentally, in the first embodiment, each of the valves 57 and 58 is formed to have a diameter of about 5 millimeters (hereinafter abbreviated to “mm”) and a weight of about 2 grams (hereinafter abbreviated to “g”).

As described above, in the first embodiment, positive gas pressure is supplied from the air pump 18 into the ink cartridge 2 through the flow path A when the purging process is executed, whereas gas in the ink cartridge 2 flows out to the outside through the flow path B rapidly until the gas pressure in the ink cartridge 2 almost approaches the atmospheric air pressure when the air pump 18 is stopped. Accordingly, because the gas pressure in the ink cartridge 2 can be regulated rapidly when the purging process is executed, the purging process can be executed without discharge of surplus ink. Moreover, because communication between the inside and the outside of the ink cartridge 2 can be generally blocked by the weight of each of the valves 57 and 58, the water content of ink can be prevented from being vaporized.

Incidentally, the formation of the flow paths A and B is not limited to the case where the purging process is executed. When, for example, the gas pressure in the ink cartridge 2 increases because of temperature rise in accordance with change in the ambient environment, the flow path B can be formed so that high-pressure gas can be emitted to the outside to prevent ink from leaking out of the recording head.

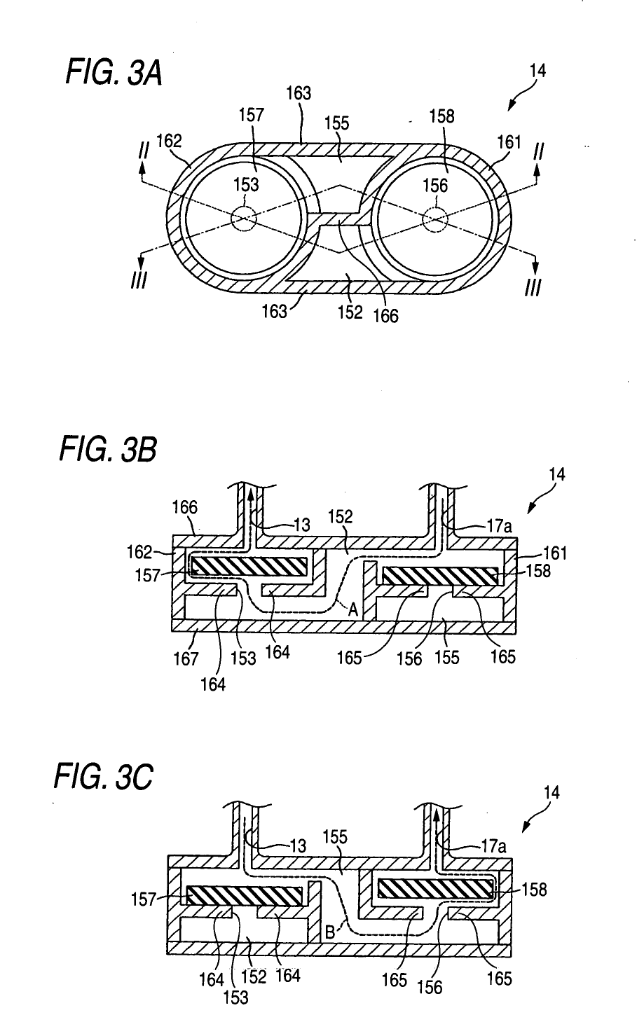

Next, a second embodiment will be described with reference to FIGS. 3A to 3C. FIGS. 3A to 3C are enlarged sectional views showing the atmospheric air communication control portion 14 in the second embodiment. Parts the same as those in the first embodiment are denoted by reference numerals the same as those in the first embodiment for the sake of omission of duplicated description.

The atmospheric air communication control portion 14 in the second embodiment has a shape in which two cylindrical housings 161 and 162 having built-in valves 158 and 157 respectively are arranged side by side so that outer circumferential walls of the cylindrical housings 161 and 162 are integrally connected to each other by side walls 163 and 163. Upper and lower open surfaces of the atmospheric air communication control portion 14 are covered with covers 166 and 167 respectively. The two housings 161 and 162 have partition walls 165 and 164 respectively so that the inside of each of the housings 161 and 162 is partitioned into upper and lower parts in almost the same manner as in the first embodiment. Valves 158 and 157 are supported on the partition walls 165 and 164 respectively. In an ordinary state, communication holes 153 and 156 formed in the partition walls 164 and 165 are blocked with the valves 157 and 158 respectively on the basis of the weight of each of the valves 157 and 158.

A space between the two housings 161 and 162 is partitioned into two communication paths 152 and 155 by a partition wall 166 extending vertically between the outer circumferential walls of the two housings 161 and 162. One housing 161 has an opening provided in its side surface for connecting the upper space of the housing 161 to one communication path 152, and an opening provided in its side surface for connecting the lower space of the housing 161 to the other communication path 155. The other housing 162 has an opening provided in its side surface for connecting the lower space of the housing 162 to one communication path 152, and an opening provided in its side surface for connecting the upper space of the housing 162 to the other communication path 155. Accordingly, the upper space of one housing 161 and the lower space of the other housing 162 are connected to each other through one communication path 152 while the lower space of one housing 161 and the upper space of the other housing 162 are connected to each other through the other communication path 155.

The upper space of one housing 161 is connected to the air pump 18 through a tube 17a while the upper space of the other housing 162 is connected into the ink cartridge 2 through an atmospheric air communication path 13.

In an ordinary printing state, the communication holes 156 and 153 are blocked with the valves 158 and 157 respectively in the same manner as in the first embodiment. When the inner pressure of the ink cartridge 2 is reduced in accordance with consumption of ink in the ink cartridge 2, the valve 157 is lifted on the basis of the pressure difference between the upper and lower spaces of the housing 162 so that the atmospheric air is led into the ink cartridge 2 through the inside of the air pump 18 in a stop state.

When the purging process is executed so that positive gas pressure is supplied by the air pump 18 in the same manner as in the first embodiment, the valve 157 is lifted by the gas pressure given from below so that the positive gas pressure is applied into the ink cartridge 2 (flow path A in FIG. 3B). As a result, ink is discharged from the nozzle holes.

When supply of the positive gas pressure by the air pump 18 is stopped, the pressure of the air pump 18 side space is restored to the atmospheric air pressure rapidly by the valve 158 but the positive-pressure gas remains in the ink cartridge 2. The gas in the ink cartridge 2 flows out to the outside while lifting the valve 158 on the basis of the differential pressure. When the gas pressure in the ink cartridge 2 almost approaches the atmospheric air pressure, the valve 158 moves down on the basis of its own weight to block communication between the inside of the ink cartridge 2 and the atmospheric air.

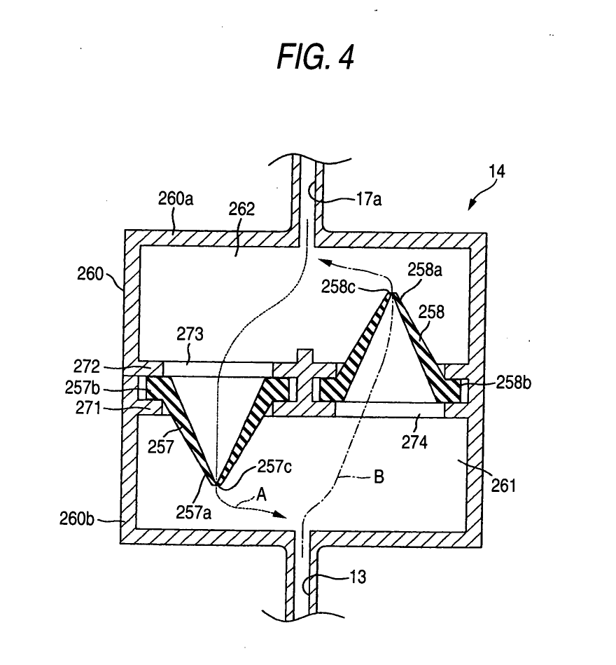

Next, a third embodiment will be described with reference to FIG. 4. FIG. 4 is an enlarged sectional view showing the atmospheric air communication control portion 14 in the third embodiment. Incidentally, parts the same as those in the first embodiment are denoted by reference numerals the same as those in the first embodiment for the sake of omission of duplicated description.

The atmospheric air communication control portion 14 in the third embodiment has a hollow housing 260 formed by the connection of two housing parts 260a and 260b, and two valves 257 and 258. Each of the valves 257 and 258 is made of an elastic member such as rubber. Each valve 257 (or 258) has a tapered shape in which the valve 257 (or 258) rises in a direction of its central axis from an annular base portion 257b (or 258b) so that the width of the valve 257 (or 258) in a direction is tapered to a tip end 257a (or 258a). Slits 257c and 258c are provided at the tip ends 257a and 258a respectively. In an ordinary state, the slits are closed on the basis of the elasticity of the valve material. When the pressure of a space surrounding the protrusion side of each valve is reduced to be lower by at least a predetermined value than the pressure of a space on the opposite side, the slit is opened against the elasticity of the valve material to permit gas to flow from the latter space into the former space.

The two housing parts 260a and 260b constituting the hollow housing 260 have flanges 271 and 272 on opposite open surfaces respectively. Each of the flanges 271 and 272 is provided with two opening portions 273 and 274. The valves 257 and 258 are formed so that the annular base portions 257b and 258b of the valves 257 and 258 are clamped and fixed between the flanges 271 and 272 in circumferential edges of the opening portions 273 and 274. The valves 257 and 258 are disposed so as to protrude in opposite directions from the flanges 271 and 272 respectively.

The inside of the hollow housing 260 is partitioned into two spaces 261 and 262 by the flanges 271 and 272 and the valves 257 and 258. One space 261 is connected into the ink cartridge 2 through the atmospheric air communication path 13 while the other space 262 is connected to the air pump 18 through the tube 17a.

In an ordinary printing state, the slits 257c and 258c are closed as described above. When the inner pressure of the ink cartridge 2 is reduced in accordance with consumption of ink in the ink cartridge 2, the valve 257 protruding to the low pressure side opens the slit 257c on the basis of the difference between the atmospheric air pressure and the ink cartridge side pressure. As a result, the atmospheric air flows into the ink cartridge 2 through the inside of the air pump 18 in a stop state. On this occasion, the valve 258 protrudes from the low pressure side to the high pressure side, so that the valve 258 acts to close the slit 258c.

When the purging process is executed so that positive gas pressure is supplied by the air pump 18 in the same manner as in the first embodiment and increased to be higher by at least a predetermined value than the inner pressure of the ink cartridge 2, the slit 257c of the valve 257 is opened to supply positive gas pressure into the ink cartridge 2 (flow path A) to thereby discharge ink from the nozzle holes.

When supply of the positive gas pressure by the air pump 18 is stopped, the slit 257c of the valve 257 is closed so that the pressure of the space 262 formed on the air pump 18 side with respect to the valve 257 is restored to the atmospheric air pressure rapidly but the positive-pressure gas remains in the ink cartridge 2. As a result, the gas in the ink cartridge 2 flows to the outside while opening the slit 258c of the valve 258 on the basis of the differential pressure. When the gas pressure in the ink cartridge 2 almost approaches the atmospheric air pressure, the slit 258c of the valve 258 is closed to block communication between the inside and the outside of the ink cartridge 2. Incidentally, in the third embodiment, the base portion of each of the valves 257 and 258 is formed to have a diameter of about 5 mm.

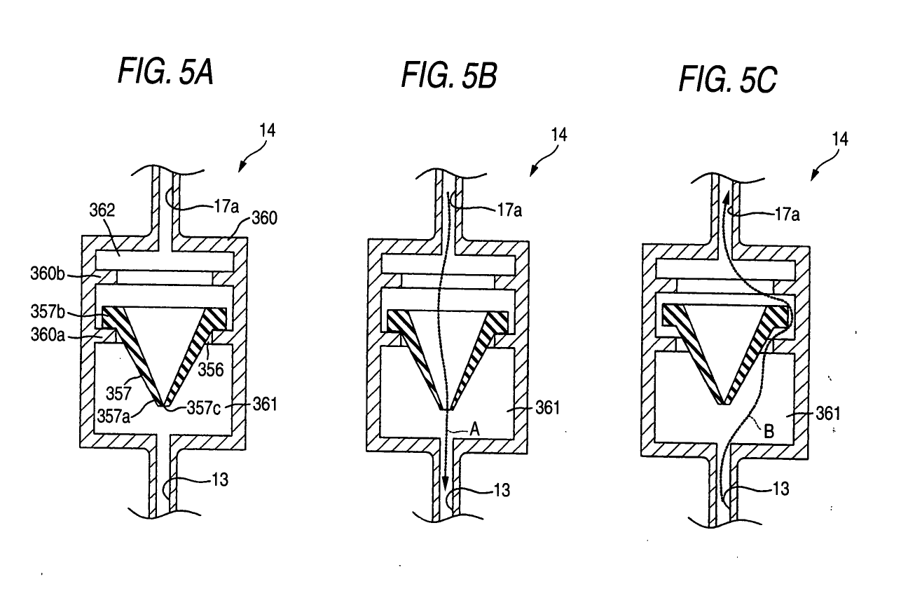

Next, a fourth embodiment will be described with reference to FIGS. 5A to 5C. FIGS. 5A to 5C are enlarged sectional views showing the configuration of the atmospheric air communication control portion 14 in the fourth embodiment. FIG. 5A shows an ordinary state of the atmospheric air communication control portion 14. FIG. 5B shows a state in which gas flows into the ink cartridge 2. FIG. 5C shows a state in which gas flows out of the ink cartridge 2. Incidentally, parts the same as those in the first embodiment are denoted by reference numerals the same as those in the first embodiment for the sake of omission of duplicated description.

The atmospheric air communication control portion 14 in the fourth embodiment is formed in such a manner that a valve 357 having almost the same shape as that of each of the valves 257 and 258 in the third embodiment is disposed in a hollow cylindrical housing 360 so as to be movable. The housing 360 has a structure in which two housing parts are bonded to each other in the condition that open surfaces of the housing parts face each other. The housing 360 has annular flanges 360a and 360b which are provided in the bonding portion so that a distance is formed between the annular flanges 360a and 360b. The housing 360 is partitioned into spaces 361 and 362 by the flanges 360a and 360b. The lower space 361 of the housing 360 is connected into the ink cartridge 2 through the atmospheric air communication path 13 while the upper space 362 of the housing 360 is connected to the air pump 18 through the tube 17a.

The valve 357 has a base portion 357b clamped and supported between the flanges 360a and 360b so as to be movable in a direction of the central axis of the housing 360, and a tip end 357 a protruded to the lower space 361 while passing through a communication hole 356 formed in the lower flange 360a. In an ordinary state, the base portion 357b abuts on the lower flange 360a on the basis of its own weight to close the communication hole 356. When the pressure of the lower space 361 becomes higher than the pressure of the upper space 362, the base portion 357b is lifted on the basis of the differential pressure to open the communication hole 356. In this manner, the base portion 357b serves as a valve. A gap is formed between the outer circumference of the base portion 357b and the inner surface of the housing 360. When the communication hole 356 is opened, gas is permitted to circulate through the gap. Preferably, bumpy portions are provided in facing surfaces of the base portion 357b and the upper flange 360b so that the base portion 357b can be prevented from adhering to the upper flange 360b to block the flow path when the base portion 357b is lifted.

A slit 357c is provided at the tip end 357a of the valve 357. In an ordinary state, the slit 357c is closed on the basis of the elasticity of the valve material per se in the same manner as in the previous embodiment. When the pressure of the upper space 362 becomes higher than the pressure of the lower space 361, the slit 357c is opened against the elasticity.

In an ordinary printing state, the base portion 357b of the valve 357 closes the communication hole 356 while the slit 357c of the valve 357 is closed. When the inner pressure of the ink cartridge 2 is reduced in accordance with consumption of ink in the ink cartridge 2, the slit 357c is opened on the basis of the difference between the inner pressure of the ink cartridge 2 and the atmospheric air pressure of the upper space. As a result, the atmospheric air is led into the ink cartridge 2 through the inside of the air pump 18 in a stop state.

When the purging process is executed so that positive gas pressure is supplied by the air pump 18 in the same manner as in the first embodiment and increased to be higher by at least a predetermined value than the inner pressure of the ink cartridge 2, the slit 357c of the valve 357 is opened to supply positive gas pressure into the ink cartridge 2 (flow path A) to thereby discharge ink from the nozzle holes.

When supply of the positive gas pressure by the air pump 18 is stopped, the slit 357c of the valve 357 is closed so that the pressure of the upper space 362 is restored to the atmospheric air pressure rapidly but the positive-pressure gas remains in the ink cartridge 2. As a result, when the pressure difference between the two is not lower than a predetermined value, the base portion 357b of the valve 357 is lifted to open the communication hole 356 so that gas flows out to the outside (flow path B). When the gas pressure in the ink cartridge 2 almost approaches the atmospheric air pressure, the valve 357 moves down on the basis of its own weight. As a result, the valve 357 is supported by the flange 360a to block communication between the inside and the outside of the ink cartridge 2. Incidentally, in the fourth embodiment, the bottom of the circulating member 357 is formed to have a diameter of about 5 mm and a weight of about 2 g.

Although the invention has been described above on the basis of embodiments, it cane conceived easily that the invention is not limited to the embodiments at all and that various changes and modifications may be made without departing from the gist of the invention.

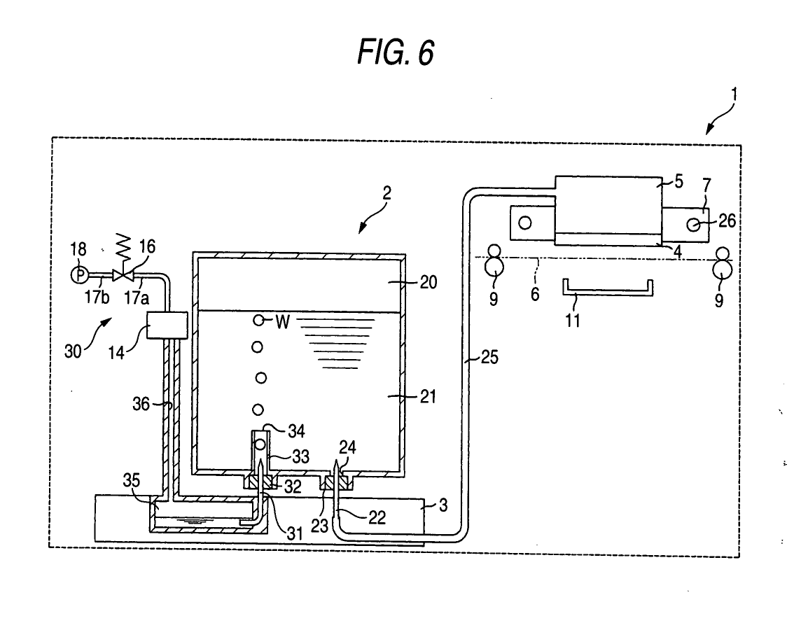

Although the embodiments have been described on the case where the atmospheric air communication path 13 is formed on an upper side opposite to the ink discharge side of the ink cartridge 2, the invention may be also applied to the case where a hollow atmospheric air introduction needle 31 is disposed substantially in parallel with the extracting needle 22. An example of this configuration will be described with reference to FIG. 6.

FIG. 6 is a diagram typically showing an inkjet recording apparatus 1. A section of an ink cartridge 2 is shown in FIG. 6. Incidentally, parts the same as those in the aforementioned embodiments are denoted by reference numerals the same as those in the aforementioned embodiments for the sake of omission of duplicated description. As shown in FIG. 6, a hollow atmospheric air introduction needle 31 and a buffer tank 35 are provided in the mount portion 3. The hollow atmospheric air introduction needle 31 is disposed substantially in parallel with the extracting needle 22 and provided for introducing gas into the ink cartridge 2. Ink is reserved in the buffer tank 35 so that a lower end of the atmospheric air introduction needle 31 is immersed in the ink. An upper space in the buffer tank 35 is connected to the atmospheric air through an atmospheric air communication path 36 formed in a stand-pipe 36. When the ink cartridge 2 is mounted on the mount portion 3, the atmospheric air introduction needle 31 pierces a stopper 32 so that a pointed end of the atmospheric air introduction needle 31 enters a cylindrical tube member 33 opened at an opening 34 and comes into contact with ink.

The atmospheric air communication control portion 14 produced in any one of the aforementioned embodiments is connected to an upper end of the stand pipe 36. The positive-pressure purging device 30 is connected to the atmospheric air communication control portion 14 in the same manner as in the first embodiment.

In an ordinary printing state, when the inner pressure of the ink cartridge 2 is reduced in accordance with consumption of ink in the ink cartridge 2, the air in the buffer tank 35 is led into the ink cartridge 2 through the hollow atmospheric air introduction needle 31. On this occasion, the atmospheric air is led into the space in the buffer tank 35 through the atmospheric air communication control portion 14 as described above in each of the aforementioned embodiments.

When the purging process is executed by the positive-pressure purging device 30, positive gas pressure is supplied into the buffer tank 35 through the atmospheric air communication control portion 14 as described above in each of the aforementioned embodiments. Moreover, high pressure is applied on ink in the ink cartridge 2 through the hollow atmospheric air introduction needle 31, so that ink is discharged from the nozzle holes of the recording head. When the purging process is completed, high-pressure gas in the buffer tank 35 is emitted through the atmospheric air communication control portion 14 as described above in each of the embodiments.

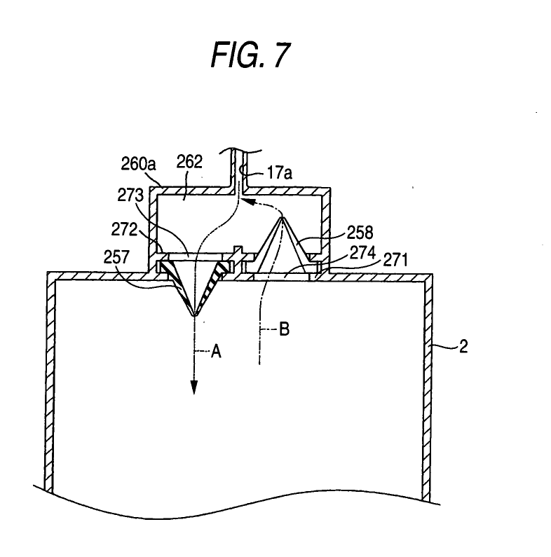

The atmospheric air communication control portion 14 produced in any one of the embodiments may be formed so as to be integrated with the ink cartridge 2 or the buffer tank 35. For example, as shown in FIG. 7, the lower housing part 260b in the third embodiment may be omitted. That is, a lower flange 271 is formed on an upper wall of the ink cartridge 2. An upper housing part 260a is bonded to the lower flange 271 so as to be opposite to the lower flange 271. Valves 257 and 258 are disposed between the lower flange 271 and the upper housing part 260a. The atmospheric air communication control portion 14 produced in another embodiment may be also formed so as to be integrated with the ink cartridge 2 in such a manner that a part of the housing is provided so as to serve as a wall of the ink cartridge 2.

In the aforementioned embodiments, only pressure provided by the positive-pressure purging device 30 is used for the purging process. However, as commonly known, the nozzle holes of the recording head may be covered with a suction cap (not shown) so that ink can be sucked from the nozzle holes on the basis of negative pressure by a suction pump. Or negative-pressure suction may be used in combination with positive-pressure purging. When negative-pressure suction is used or when negative-pressure suction is used in combination with positive-pressure purging, the positive-pressure purging device 30 may be only driven so that an operation of giving positive pressure to ink in the ink cartridge 2 is carried out in a period of from a point of time of start of negative-pressure suction to a point of time just after disconnection of the suction cap from the nozzle holes to thereby prevent ink discharged into the suction cap from being sucked into the nozzle holes by back pressure.

According to the inkjet recording apparatus 1 described in the above embodiments, when the difference between the pressure of positive-pressure gas supplied from the outside to the reserving portion 2 for reserving ink by the positive-pressure supply unit and the inner pressure of the reserving portion 2 is not lower than the first predetermined value, positive-pressure gas flows from the outside into the reserving portion 2 through the first flow path. When the positive gas pressure is supplied into the reserving portion 2, positive pressure is applied on ink in the ink ejecting nozzle holes of the recording head 4 through the ink reserved in the reserving portion 2. On the other hand, when the difference between the inner pressure of the reserving portion 2 and the pressure of the outside is not lower than the second predetermined value, gas flows out from the reserving portion 2 to the outside through the second flow path. For this reason, the reserving portion 2 can be ordinarily disconnected from the outside to suppress vaporization of the water content of ink. Moreover, positive gas pressure remaining in the reserving portion 2 can be rapidly emitted to the outside while positive gas pressure caused by the purging process or the like can be rapidly supplied into the reserving portion 2. Accordingly, there is an effect that the printing operation and the purging process can be executed efficiently while ink leakage from the nozzle holes can be prevented from being caused by the remaining pressure.

Moreover, even in the case where, the pressure of gas in the reserving portion 2 is increased because of temperature rise in accordance with environmental change in surroundings of the reserving portion, the pressure can be emitted to the outside. Accordingly, there is an effect that ink leakage can be prevented.

According to the embodiments, in addition to the effect described above, there is an effect that circulation of gas between the outside and the inside of the reserving portion 2 can be surely regulated by a first valve unit and a second valve unit because the first flow path has the first valve unit for permitting positive gas pressure to be supplied from the positive-pressure supply unit into the reserving portion whereas the second flow path has the second valve unit for permitting positive gas pressure to flow out from the reserving portion to the outside.

According to the embodiments, at least one of the first and second flow paths has a support portion provided with a communication hole 53, 56, 153, 156 which is formed so that the gas is permitted to pass through the communication hole, and one of the first and second valve units provided in the first and second flow paths opens the communication hole when the pressure difference is not lower than the predetermined value, but is ordinarily urged to abut on the support portion to thereby close the communication hole. Accordingly, in addition to the effect provided by the inkjet recording apparatus described above, there is an effect that circulation between the reserving portion 2 and the outside through the first and second flow paths can be ordinarily blocked to suppress vaporization of the water content of ink but can be permitted when the pressure difference is not lower than the predetermined value.

According to the embodiments, in addition to the effect provided by the inkjet recording apparatus described above, there is an effect that circulation between the reserving portion 2 and the outside through the first and second flow paths in a simple configuration can be ordinarily blocked to suppress vaporization of the water content of ink but can be permitted when the pressure difference is not lower than the predetermined value because means for urging one of the first and second valve units to abut on the support portion is gravity.

According to the third and fourth embodiments, at least one of the first and second valve units has an elastic valve portion 257, 258, 357 which operates so that an opening portion for permitting the gas to pass through the opening portion is ordinarily closed by the elasticity of the elastic valve portion but opened when the pressure difference is not lower than the predetermined value. Accordingly, in addition to the effect provided by the inkjet recording apparatus described above, there is an effect that circulation between the reserving portion 2 and the outside through the first and second flow paths in a simple configuration can be ordinarily blocked to suppress vaporization of the water content of ink but can be permitted when the pressure difference is not lower than the predetermined value.

According to the fourth embodiment, the second flow path has a support portion 360a provided with a communication hole which is formed for permitting the gas to pass through the communication hole; the second valve unit opens the communication hole when the pressure difference is not lower than the second predetermined value but is ordinarily urged to abut on the support portion to close the communication hole; and the first valve unit has an elastic valve portion which is provided on the second valve unit and which operates so that an opening portion for permitting the gas to pass through the opening portion is ordinarily closed by the elasticity of the elastic valve portion but opened when the pressure difference is not lower than the first predetermined value. Accordingly, in addition to the effect provided by the ink jet recording apparatus described above, there is an effect that circulation between the reserving portion 2 and the outside through the first and second flow paths can be ordinarily blocked to suppress vaporization of the water content of ink because circulation in the second flow path is ordinarily blocked with the urged second valve unit while circulation in the first flow path is ordinarily blocked with the elastic valve portion. Moreover, the first and second valve members can be integrated as one member because the first valve member is provided on the second valve member. Accordingly, there is also an effect that reduction in size of the apparatus can be attained.

According to the third and fourth embodiments, the elastic valve portion is provided so as to protrude from an upstream side to a downstream side in a direction for permitting the gas to pass through so that a tip end of the elastic valve portion on the downstream side is closed by the elasticity of the elastic valve portion. Accordingly, in addition to the effect provided by the inkjet recording apparatus described above, there is an effect that the tip end of the elastic valve portion can be ordinarily closed to suppress vaporization of the water content of ink but can be easily opened by positive pressure to permit circulation when the pressure of gas on the upstream side is positive pressure.

According to the first embodiment, a downstream side of the second valve unit in a direction for permitting the gas to pass through and an upstream side of the first valve unit in a direction for permitting the gas to pass through are connected to each other by a first communication path; a downstream side of the first valve unit in a direction for permitting the gas to pass through and an upstream side of the second valve unit in a direction for permitting the gas to pass through are connected to each other by a second communication path; and the positive-pressure supply unit is connected to the first communication path while the reserving portion 2 is connected to the second communication path. Accordingly, in addition to the effect provided by the inkjet recording apparatus described above, there is an effect that positive gas pressure can keep one valve unit closed and can open the other valve unit easily to circulate the gas to regulate the inner pressure of the reserving portion rapidly though the two valve units ordinarily close the paths.

According to the ink cartridge described in the above embodiments, when the difference between the pressure of positive-pressure gas supplied from the outside to the reserving portion 2 for reserving ink by the positive-pressure supply unit provided in the inkjet recording apparatus 1 and the inner pressure of the reserving portion 2 is not lower than the first predetermined value, positive-pressure gas flows from the outside into the reserving portion 2 through the first flow path. When the positive gas pressure is supplied into the reserving portion 2, positive pressure is applied on ink in the ink ejecting nozzle holes of the recording head through the ink reserved in the reserving portion. On the other hand, when the difference between the inner pressure of the reserving portion 2 and the pressure of the outside is not lower than the second predetermined value, gas flows out from the reserving portion 2 to the outside through the second flow path. For this reason, the reserving portion can be ordinarily disconnected from the outside to suppress vaporization of the water content of ink. Moreover, positive gas pressure remaining in the reserving portion 2 can be rapidly emitted to the outside while positive gas pressure caused by the purging process or the like can be rapidly supplied into the reserving portion. Accordingly, there is an effect that the printing operation and the purging process can be executed efficiently while ink leakage from the nozzle holes can be prevented from being caused by the remaining pressure.

Moreover, even in the case where the pressure of gas in the reserving portion 2 is increased because of temperature rise in accordance with environmental change in surroundings of the reserving portion, the pressure can be emitted to the outside. Accordingly, there is an effect that ink leakage can be prevented.

According to the embodiments, in addition to the effect provided by the ink cartridge described above, there is an effect that circulation of gas between the outside and the inside of the reserving portion 2 can be surely regulated by a first valve unit and a second value unit because the first flow path has the first valve unit for permitting positive gas pressure to be supplied from the positive-pressure supply unit into the reserving portion 2 whereas the second flow path has the second valve unit for permitting positive gas pressure to flow out from the reserving portion 2 to the outside.

According to the embodiments, at least one of the first and second flow paths has a support portion provided with a communication hole which is formed so that the gas is permitted to pass through the communication hole, and one of the first and second valve units provided in the first and second flow paths opens the communication hole when the pressure difference is not lower than the predetermined value, but is ordinarily urged to abut on the support portion to thereby close the communication hole. Accordingly, in addition to the effect provided by the ink cartridge described above, there is an effect that circulation between the reserving portion and the outside through the first and second flow paths can be ordinarily blocked to suppress vaporization of the water content of ink but can be permitted when the pressure difference is not lower than the predetermined value.

According to the embodiments, in addition to the effect provided by the ink cartridge described above, there is an effect that circulation between the reserving portion 2 and the outside through the first and second flow paths in a simple configuration can be ordinarily blocked to suppress vaporization of the water content of ink but can be permitted when the pressure difference is not lower than the predetermined value because means for urging one of the first and second valve units to abut on the support portion is gravity.

According to the embodiments, at least one of the first and second valve units has an elastic valve portion which operates so that an opening portion for permitting the gas to pass through the opening portion is ordinarily closed by the elasticity of the elastic valve portion but opened when the pressure difference is not lower than the predetermined value. Accordingly, in addition to the effect provided by the ink cartridge described above, there is an effect that circulation between the reserving portion 2 and the outside through the first and second flow paths in a simple configuration can be ordinarily blocked to suppress vaporization of the water content of ink but can be permitted when the pressure difference is not lower than the predetermined value.

According to the embodiments, the second flow path has a support portion provided with a communication hole which is formed for permitting the gas to pass through the communication hole; the second valve unit opens the communication hole when the pressure difference is not lower than the second predetermined value but is ordinarily urged to abut on the support portion to close the communication hole; and the first valve unit has an elastic valve portion which is provided on the second valve unit and which operates so that an opening portion for permitting the gas to pass through the opening portion is ordinarily closed by the elasticity of the elastic valve portion but opened when the pressure difference is not lower than the first predetermined value. Accordingly, in addition to the effect provided by the ink cartridge described above, there is an effect that circulation between the reserving portion 2 and the outside through the first and second flow paths can be ordinarily blocked to suppress vaporization of the water content of ink because circulation in the second flow path is ordinarily blocked with the urged second valve unit while circulation in the first flow path is ordinarily blocked with the elastic valve portion. Moreover, the first and second valve members can be integrated as one member because the first valve member is provided on the second valve member. Accordingly, there is also an effect that reduction in size of the apparatus can be attained.

According to the embodiments, the elastic valve portion is provided so as to protrude from an upstream side to a downstream side in a direction for permitting the gas to pass through so that a tip end of the elastic valve portion on the downstream side is closed by the elasticity of the elastic valve portion. Accordingly, in addition to the effect provided by the ink cartridge described above, there is an effect that the tip end of the elastic valve portion can be ordinarily closed to suppress vaporization of the water content of ink but can be easily opened by positive pressure to permit circulation when the pressure of gas on the upstream side is positive pressure.

According to the embodiments, a downstream side of the second valve unit in a direction for permitting the gas to pass through and an upstream side of the first valve unit in a direction for permitting the gas to pass through are connected to each other by a first communication path; a downstream side of the first valve unit in a direction for permitting the gas to pass through and an upstream side of the second valve unit in a direction for permitting the gas to pass through are connected to each other by a second communication path; and the positive-pressure supply unit is connected to the first communication path while the reserving portion 2 is connected to the second communication path. Accordingly, in addition to the effect provided by the ink cartridge described above, there is an effect that positive gas pressure can keep one valve unit closed and can open the other valve unit easily to circulate the gas to regulate the inner pressure of the reserving portion rapidly though the two valve units ordinarily close the paths.

While the invention has been described in conjunction with the specific embodiments described above, many equivalent alternatives, modifications and variations may become apparent to those skilled in the art when given this disclosure. Accordingly, the exemplary embodiments of the invention as set forth above are considered to be illustrative and not limiting. Various changes to the described embodiments may be made without departing from the spirit and scope of the invention.

1. An inkjet recording apparatus comprising:
a recording head having nozzle holes for ejecting ink;
a reserving portion that reserves ink to be supplied to the recording head;
a positive-pressure supply unit that supplies positive gas pressure from the outside into the reserving portion to apply positive pressure on the ink in the nozzle holes of the recording head through the ink reserved in the reserving portion;
a first flow path through which positive-pressure gas flows from the outside into the reserving portion by the positive-pressure supply unit when the difference between the pressure of positive-pressure gas provided by the positive-pressure supply unit and the inner pressure of the reserving portion is not lower than a first predetermined value; and
a second flow path through which gas flows out from the reserving portion to the outside when the difference between the inner pressure of the reserving portion and the pressure of the outside is not lower than a second predetermined value.

2. The inkjet recording apparatus according to claim 1, wherein the first flow path has a first valve unit that permits positive gas pressure to be supplied from a positive-pressure supply unit side to a reserving portion side; and
the second flow path has a second valve unit that permits positive gas pressure to flow out from the reserving portion side to the outside.

3. The inkjet recording apparatus according to claim 2, wherein at least one of the first and second flow paths has a support portion provided with a communication hole which is formed so that the gas is permitted to pass through the communication hole; and
one of the first and second valve units provided in the first and second flow paths opens the communication hole when the pressure difference is not lower than the first or second predetermined value, but is ordinarily urged to abut on the support portion to thereby close the communication hole.

4. The inkjet recording apparatus according to claim 3, wherein gravity urges one of the first and second valve units to abut on the support portion.

5. The inkjet recording apparatus according to claim 2, wherein at least one of the first and second valve units has an elastic valve portion which operates so that an opening portion for permitting the gas to pass through the opening portion is ordinarily closed by the elasticity of the elastic valve portion but opened when the pressure difference is not lower than the first or second predetermined value.

6. The inkjet recording apparatus according to claim 2, wherein the second flow path has a support portion provided with a communication hole which is formed for permitting the gas to pass through the communication hole;
the second valve unit opens the communication hole when the pressure difference is not lower than the second predetermined value but is ordinarily urged to abut on the support portion to close the communication hole; and
the first valve unit has an elastic valve portion which is provided on the second valve unit and which operates so that an opening portion for permitting the gas to pass through the opening portion is ordinarily closed by the elasticity of the elastic valve portion but opened when the pressure difference is not lower than the first predetermined value.

7. The inkjet recording apparatus according to claim 5, wherein the elastic valve portion is provided so as to protrude from an upstream side to a downstream side in a direction for permitting the gas to pass through and a tip end of the elastic valve portion on the downstream side is closed by the elasticity of the elastic valve portion.

8. The inkjet recording apparatus according to claim 2, wherein a downstream side of the second valve unit in a direction for permitting the gas to pass through and an upstream side of the first valve unit in a direction for permitting the gas to pass through are connected to each other by a first communication path;
a downstream side of the first valve unit and an upstream side of the second valve unit are connected to each other by a second communication path; and
the positive-pressure supply unit is connected to the first communication path while the reserving portion is connected to the second communication path.

9. An ink cartridge used in an inkjet recording apparatus including a recording head having nozzle holes for ejecting ink, a reserving portion that reserves ink to be supplied to the recording head, and a positive-pressure supply unit that supplies positive gas pressure from the outside into the reserving portion to apply positive pressure on the ink in the nozzle holes of the recording head through the ink reserved in the reserving portion, the ink cartridge comprising:
the reserving portion;
a first flow path through which positive-pressure gas flows from the outside into the reserving portion by the positive-pressure supply unit when the difference between the pressure of positive-pressure gas provided by the positive-pressure supply unit and the inner pressure of the reserving portion is not lower than a first predetermined value; and
a second flow path through which gas flows out from the reserving portion to the outside when the difference between the inner pressure of the reserving portion and the pressure of the outside is not lower than a second predetermined value.

10. The ink cartridge according to claim 9, wherein the first flow path has a first valve unit that permits positive gas pressure to be supplied from a positive-pressure supply unit side to a reserving portion side; and
the second flow path has a second valve unit that permits positive gas pressure to flow out from the reserving portion side to the outside.

11. The ink cartridge according to claim 10, wherein at least one of the first and second flow paths has a support portion provided with a communication hole which is formed so that the gas is permitted to pass through the communication hole; and
one of the first and second valve units provided in the first and second flow paths opens the communication hole when the pressure difference is not lower than the first or second predetermined value, but is ordinarily urged to abut on the support portion to thereby close the communication hole.

12. The ink cartridge according to claim 11, wherein gravity urges one of the first and second valve units to abut on the support portion.

13. The ink cartridge according to claim 10, wherein at least one of the first and second valve units has an elastic valve portion which operates so that an opening portion for permitting the gas to pass through the opening portion is ordinarily closed by the elasticity of the elastic valve portion but opened when the pressure difference is not lower than the predetermined value.

14. The ink cartridge according to claim 10, wherein the second flow path has a support portion provided with a communication hole which is formed for permitting the gas to pass through the communication hole;
the second valve unit opens the communication hole when the pressure difference is not lower than the second predetermined value but is ordinarily urged to abut on the support portion to close the communication hole; and
the first valve unit has an elastic valve portion which is provided on the second valve unit and which operates so that an opening portion for permitting the gas to pass through the opening portion is ordinarily closed by the elasticity of the elastic valve portion but opened when the pressure difference is not lower than the first predetermined value.

15. The ink cartridge according to claim 13, wherein the elastic valve portion is provided so as to protrude from an upstream side to a downstream side in a direction for permitting the gas to pass through and a tip end of the elastic valve portion on the downstream side is closed by the elasticity of the elastic valve portion.

16. The ink cartridge according to claim 10, wherein a downstream side of the second valve unit in a direction for permitting the gas to pass through and an upstream side of the first valve unit in a direction for permitting the gas to pass through are connected to each other by a first communication path;
a downstream side of the first valve unit and an upstream side of the second valve unit are connected to each other by a second communication path; and
the positive-pressure supply unit is connected to the first communication path while the reserving portion is connected to the second communication path.

17. An inkjet recording apparatus comprising:
a recording head having nozzle holes for ejecting ink;
a reserving portion that reserves ink to be supplied to the recording head;
a positive-pressure supply unit that supplies positive gas pressure from the outside into the reserving portion to apply positive pressure on the ink in the nozzle holes of the recording head through the ink reserved in the reserving portion; and
an atmospheric air communication control portion disposed between the reserving portion and the positive-pressure supply unit, the atmospheric air communication control portion having a first flow path through which positive-pressure gas flows from the outside into the reserving portion by the positive-pressure supply unit when the difference between the pressure of positive-pressure gas provided by the positive-pressure supply unit and the inner pressure of the reserving portion is not lower than a first predetermined value, and a second flow path through which gas flows out from the reserving portion to the outside when the difference between the inner pressure of the reserving portion and the pressure of the outside is not lower than a second predetermined value.

18. The inkjet recording apparatus according to claim 17, wherein the atmospheric air communication control portion comprises first and second hollow housings through which the positive-pressure gas from the outside and the gas from the reserving portion flow.

19. The inkjet recording apparatus according to claim 18, wherein each of the first and second hollow housings has a valve unit which switch the first and second flow paths.

20. The inkjet recording apparatus according to claim 18, wherein the positive-pressure gas from the outside flows to the first hollow housing and then to the second hollow housing whereas the gas from the reserving portion flows to the second hollow housing and then to the first hollow housing.

21. The inkjet recording apparatus according to claim 17, wherein the atmospheric air communication control portion comprises:
a hollow housing having a flange on an inner surface there of; and
a valve unit that permits positive gas pressure to be supplied from a positive pressure supply unit side to a reserving portion side and that permits positive gas pressure to flow out from the reserving portion side to the outside;
wherein the valve unit is ordinarily supported by the flange, but is lifted from the flange portion when the positive gas pressure flows out from the reserving portion side to the outside.
